(19) United States
(12) Patent Application Publication
(10) Pub. No.: US 2013/0258486 A1
(43) Pub. Date: Oct. 3, 2013

(54) HEAD-MOUNT DISPLAY

(71) Applicants: DUMITRU MIHAI IONESCU, San Diego, CA (US); Jeffrey Eric Taarud, Cardiff, CA (US)

(72) Inventors: DUMITRU MIHAI IONESCU, San Diego, CA (US); Jeffrey Eric Taarud, Cardiff, CA (US)

(21) Appl. No.: 13/431,830

(22) Filed: Mar. 27, 2012

(51) Int. Cl. G02B 27/01

(52) U.S. Cl. 359/630

(57) ABSTRACT

A system and method is provided for varying the apparent distance of a virtual image projected by a head-mounted display. The distance between the user and an object being viewed by the user is determined. Then, the focal distance of an eyepiece optical system in the head-mounted display is adjusted to provide a virtual image at an apparent distance that corresponds to the determined distance. The user thereby experiences an approximately seamless overlay in sharp focus of the virtual image from the display and the three-dimensional binocular image being viewed. For example, when viewing a movie screen, or other object at infinity, the focal length is adjusted to provide a virtual image at or near optical infinity. Likewise, when reading a book, or inspecting another object in close proximity, the focal length is adjusted to provide the virtual image at a nearby apparent distance.

### TECHNICAL FIELD

The present invention relates generally to a head mounted image display system, and more particularly, some embodiments relate to focal adjustments of a head mounted image display system

### DESCRIPTION OF THE RELATED ART

In a head-mounted display (HMD) with pupil-division see-through technology the optical bar is thinner than the diameter of the eye's pupil (4.0 mm), thereby light from the background can reach the eye simultaneously with the light from the display device—e.g., a 0.24″ LCD with QVGA (320×240 pixels); the field of view is, e.g., 8.94/6.72 deg. (horizontal/vertical). For example, U.S. Pat. No. 7,719,769 to Sugihara, et. al., filed on Nov. 16, 2006, the contents of which are incorporated in their entirety, details such a head-mounted display. FIG. 1A is illustrative of an embodiment of head-mounted display from the patent. A controller 100 is in communication 101 with a radio module disposed in an electronics sub-system 103 of the head mounted display. According to instructions from the controller 100, a display panel 109 display a primary image. The primary image is transmitted through an eyepiece optical system to a user. They eyepiece optical system may comprise an optical fiber image guide 104, an eyepiece window holder 106, and an eyepiece window 107. The optical fiber image guide 104 transmits light from the input at the display panel 109 to produce a secondary image 105 at the output end of the guide 104. The light 108 of the secondary image is directed through an eyepiece window holder 107 and 106.

As described above, by transmitting an image from the display panel as a secondary image by way of the optical fiber image guide, it is not necessary to locate the display panel, wirings, electric substrates or the like near the eye; it is possible to prevent the components near the eye from growing bulky, which have an adverse influence on the sense of wearing or designs. Further, the optical fiber image guide, because of having some pliability, could be used even in a folded state well compatible with various designs and adjustment mechanisms.

These head-mounted displays may have eyepiece optical systems that provide the user a virtual image of the display. FIG. 1B illustrates this arrangement. The image provided by the display 123 is passed through an eyepiece lens 121 in the eyepiece optical system, for example, a convex lens disposed in the eyepiece window 107, or a gradient-index (GRIN) lens disposed in the window holder 106. The eyepiece lens 121 has a focal length such that a virtual image 120 is provided to the user 122 at a particular apparent distance. For example, the virtual image may appear to be located at around 50 cm from the user's eye 122.

### BRIEF SUMMARY OF EMBODIMENTS OF THE INVENTION

According to various embodiments of the invention, a system and method is provided for varying the apparent distance of a virtual image projected by a head-mounted display. The distance between the user and an object being viewed by the user is determined. Then, the focal distance of an eyepiece optical system in the head-mounted display is adjusted to provide a virtual image at an apparent distance that corresponds to the determined distance. The user thereby experiences an approximately seamless overlay in sharp focus of the virtual image from the display and the three-dimensional binocular image being viewed. For example, when viewing a movie screen, or other object at infinity, the focal length is adjusted to provide a virtual image at or near optical infinity. Likewise, when reading a book, or inspecting another object in close proximity, the focal length is adjusted to provide the virtual image at a nearby apparent distance.

In some embodiments, the distance between the user and the object being viewed is determined using a ranging system. For example, a radio ranging system, an ultrasonic ranging system, or a laser ranging system may be mounted to the head mounted display and used to determined the distance between the user and the object.

In other embodiments, the distance between the user and the object the user is viewing corresponds to the focal length of the lens of the user's eye. A camera mounted in the head mounted display images the user's retina and uses focusing algorithms to determine the focal length of the user's eye. The focal length of the eyepiece optical system is then adjusted according to the determined focal length.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1A illustrates a head-mounted optical display of a type in which some embodiments of the invention may be implemented.

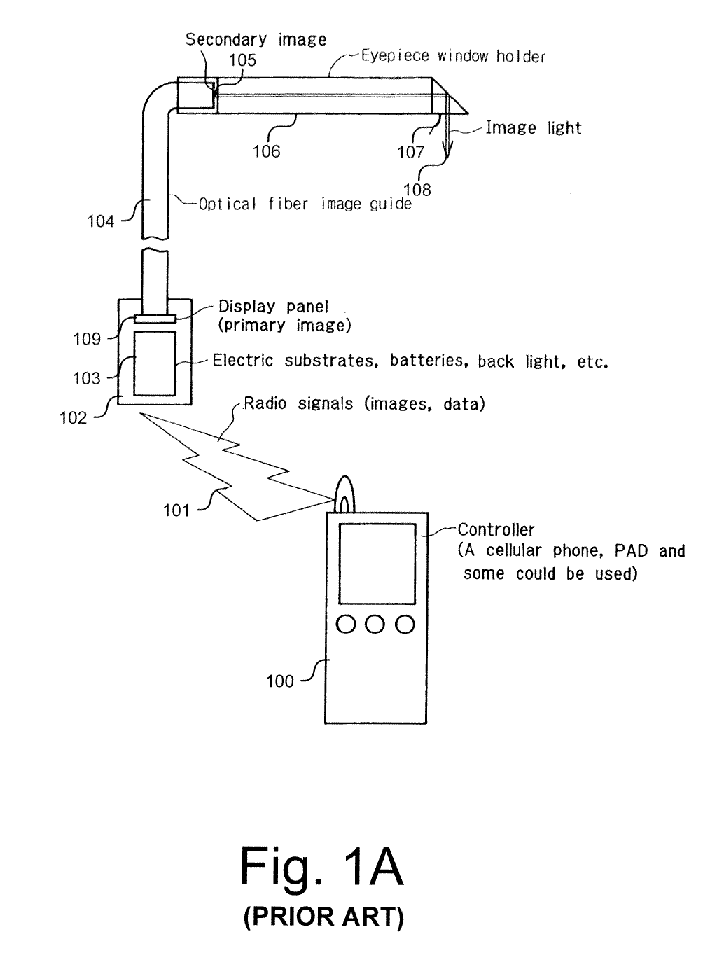

FIG. 1B illustrates the formation of a virtual image through the use of a lens in a head-mounted optical display.

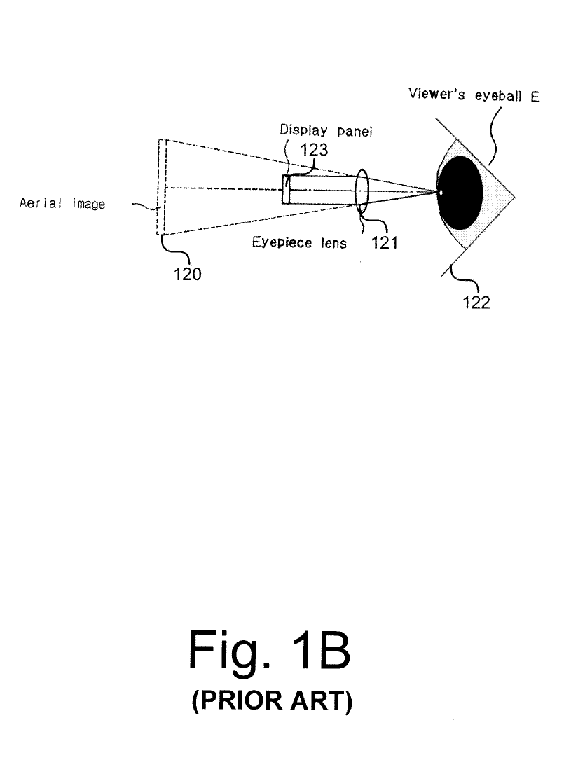

FIG. 2 illustrates an embodiment of the invention for measuring the focal length of a user's lens implemented in accordance with an embodiment of the invention.

FIG. 3 illustrates another system for measuring the distance between a user and an object implemented in accordance with an embodiment of the invention.

FIG. 4 illustrates a system for determining a viewing distance using a ranging method implemented in accordance with an embodiment of the invention.

FIG. 5 illustrates another system for determining a viewing distance in accordance with an embodiment of the invention.

FIG. 6 illustrates an example computing module that may be used in implementing various features of embodiments of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF HE EMBODIMENTS OF THE INVENTION

According to various embodiments of the invention, a system and method is provided for varying the apparent distance of a virtual image projected by a head-mounted display. The distance between the user and an object being viewed by the user is determined. Then, the focal distance of an eyepiece optical system in the head-mounted display is adjusted to provide a virtual image at an apparent distance that corresponds to the determined distance. The user thereby experiences an approximately seamless overlay in sharp focus of the virtual image from the display and the three-dimensional binocular image being viewed. For example, when viewing a movie screen, or other object at infinity, the focal length is adjusted to provide a virtual image at or near optical infinity. Likewise, when reading a book, or inspecting another object in close proximity, the focal length is adjusted to provide the virtual image at a nearby apparent distance. In various embodiments, the adaptive modification of the focal length of the head mounted display may be achieved in different ways. For example, a GRIN lens may be used with an adjustable refractive index by controlling an optical fluid. In another embodiment, microelectromechanical (MEM) devices may be used to control a system of miniature lens with fixed focal lengths to miniaturize standard adjustable focus length lens systems.

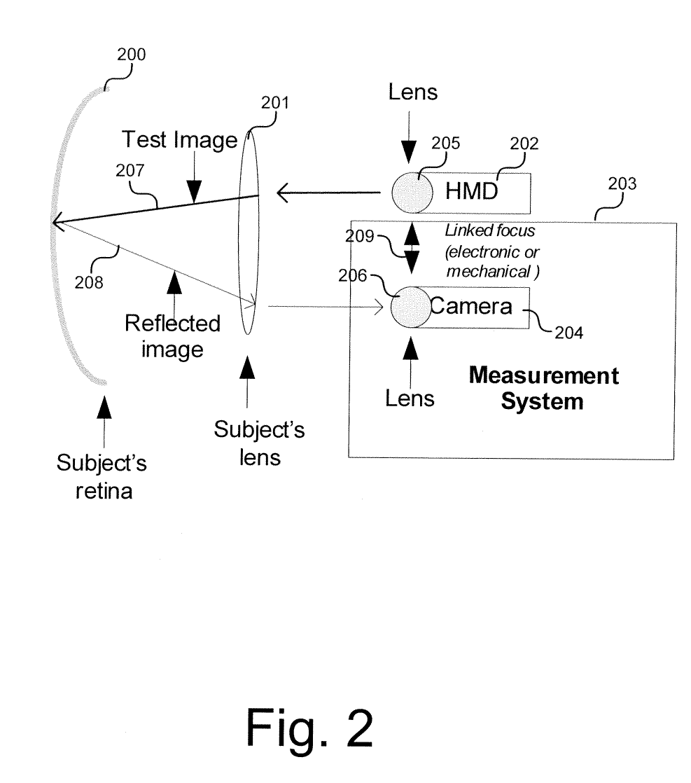

FIG. 2 illustrates an embodiment of the invention for measuring the focal length of a user's lens implemented in accordance with an embodiment of the invention. In this embodiment, a measurement system 203 is coupled to a head mounted display 202. In some embodiments, the measurement system 203 is co-housed with the head mounted display 202. In other embodiments, the measurement system 203 is communicatively coupled to the head mounted display and provided in a separate housing.

The illustrated system is configured to image a retina 200 of a subject—e.g., the wearer of the head mounted display 202—using the measurement system 203. In a particular embodiment, the head mounted display 202 projects light 207 onto the subject's retina 200 using an internal display and an eyepiece optical system 205. The eyepiece optical system 205 has an adjustable focal length, and may comprise a convex lens having an adjustable focus length, and adjustable GRIN lens, a compound lens system, a catoptric system, a catadioptric system, a combination thereof, or any other system for providing a virtual image to the subject at an apparent distance from the subject's retina 200. Throughout the present disclosure, the term “lens” may be used in reference to any optical system providing a virtual image to a subject. Context will indicate if a single lens is intended when the term “lens” is used.

In a method of adjusting the focal length of the head mounted display 202 implemented with the current embodiment, the subject focuses on an object in the real world. This results in a change in the focal length of the subject's lens 201. While the subject is focusing on the real-world object, the head mounted display 202 projects an image 207 onto the subject's retina 200. In some embodiments, the image 207 may be a predetermined test image stored in the display 202 or in the measurement system 203. In other embodiments, the image 207 may be transmitted to the head mounted display 202 or measurement system 203 by a display controller (such as a PDA, PC, or smartphone) in communicative contact with the display 202 or system 203.

The image 207 is reflected off of the subject's retina 200 to form a reflected image 208. The reflected image again passes through the subject's lens 201 and is captured by the camera 204. The camera 204 has an adjustable focus system. Additionally, the measurement system 203 is linked 209 to, and able to control, the focusing system 205 of the head mounted display 202. Implementing any standard focusing procedure, the measurement system 203 adjusts the focal length the camera's lens 206 and the focal length of the head mounted display's lens 205 such that the reflected image 208 is in focus. For example, digital image processing may be used by the measurement system 203 to measure and evaluate the known test image to determine when it is at an ideal focus point. The viewing distance of the user to the object being viewed is determined and the apparent distance of the virtual image provided by the head mounted display eyepiece optical system 207 is adjusted accordingly.

In some embodiments, the eyepiece optical system 205 does not have a continuously adjustable focal length. For example, the system 205 may have only a discrete number of different possible focal lengths. In these embodiments, the measurement system 203 may adjusts the camera's lens 206 and head mounted display's lens 205 by varying among the discrete possible focal lengths to determine which discrete focal length provides the best focus. The determination of which focal length provides the best focus may be performed according to any method known in the art.

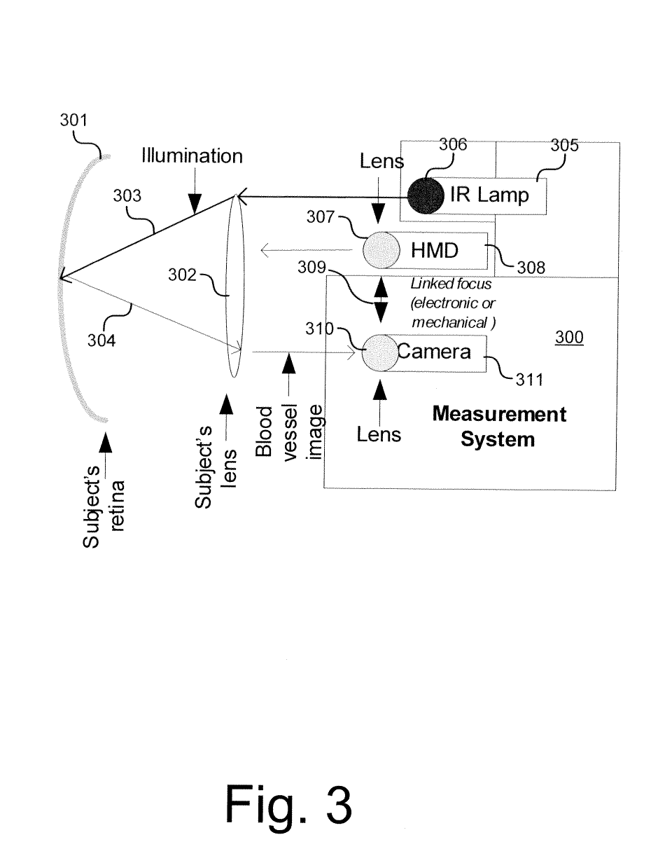

FIG. 3 illustrates another system for measuring the distance between a user and an object implemented in accordance with an embodiment of the invention. In this embodiment, the measurement system 300 comprises a camera 311 with an adjustable focal length lens 310 as in the embodiments described with respect to FIG. 2. Additionally, the measurement system 300 comprises an illumination system 305, 306, such an infrared lamp 305 with focusing lens 306.

To determine the distance from the subject to an object be viewed by the subject, the subject first focuses on the object being viewed. This results in a change of focal length of the subject's lens 302. The illumination system 305, 306 then illuminates 303 the subject's retina 301. An image 304 of the subject's retina, for example, the blood vessel pattern of the retina is then captured by the camera 311 after passing through the subject's lens 302. By adjusting the focal length of the camera lens 310, the measurement system determines the focal length of the subject's lens 302, and therefore, the viewing distance to the object being viewed by the subject. The measurement system 300 then controls 309 the focal length of the eyepiece optical system 307 to modify the apparent distance of the virtual image to correspond to the determined viewing distance. In some embodiments, the measurement system 300 determines the distance between the retina 301 and the lens 302 and uses this distance to determine the viewing distance to the object. In other embodiments, the measurement system 300 uses assumed distance from the retina 301 to lens 302, such as a biological average distance for the user. In still further embodiments, the determined viewing distance is determined relatively through the camera focus method. Then, the apparent distance of the virtual image is modified to match the camera's 311 relative determination.

In embodiments of the invention that measure features of the subject's eye, information regarding the eye may be transmitted to a controller. This information may be associated with a concurrent use as either a therapeutic method or for alerting about possible diseases of the subject's eye. Additionally, the image of the retina may be used to implement security features based on retinal identification.

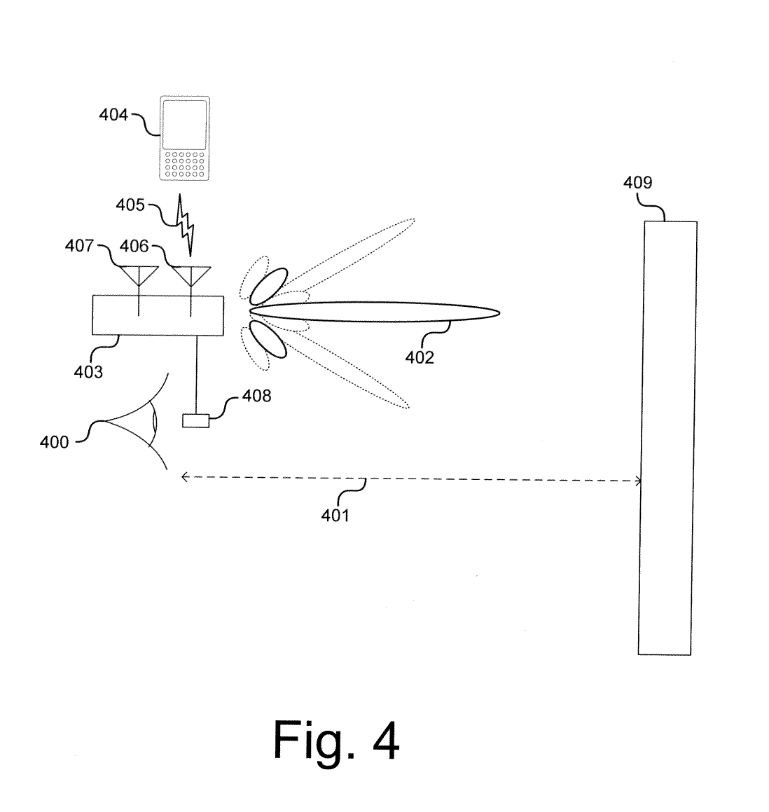

FIG. 4 illustrates a system for determining a viewing distance using a ranging method implemented in accordance with an embodiment of the invention. In this embodiment, the head mounted display system 403 includes a plurality of antennas 407, 406. For example, the antennas may be used during normal operations by a radio module disposed in the display system 403 housing to communicate 405 with a controller 404. For example, the radio module may be implemented to communicate in accordance with the 802.11ac standard, or other standard allowing communication using multiple antennas.

During normal operations the controller 404 sends 405 information to be displayed by the head mounted display 403 using the eyepiece optical system 408. Additionally, the radio module 403 of the display operates as a measurement system to perform a ranging operation to determine a viewing distance 401 between the head mounted display, or the user, to an object 409 being viewed by the user 400. During the ranging operation, the radio module measures the distance 401 between the radio module 403 and the object 409. For example, the ranging operation may be detailed in the communications protocol used to communicate 405 with the controller 404, or may be any specifically programmed ranging operation as used in the art. The ranging operation uses the multiple antennas to beam form 402 along the viewing path between the user 400 and the object 409. Measurement of the reflections from the object 409 allow the module 403 to determine and report the measured viewing distance. Using this measured distance, the focal length of the eyepiece optical system 408 is adjusted to modify the apparent distance of the virtual image displayed by the system 408.

In some embodiments, the modification of the apparent distance is to one of a discrete number of apparent distances. For example, a long or optical infinity apparent distance, a medium distance, and a close distance. This use of a discrete number of apparent distances may accommodate both the coarse nature of ranging operations performed by radio modules 403 or a lack of a continuous focus length adjustment in the system 408. In one such embodiment, the measure ent system 403 measures the range 401 and then quantizes the measurement to one of a plurality of discrete values, such as one of two or three predetermined values. These predetermined values may correspond to viewing distances commonly used by people, such as a handheld book, looking at a mobile phone display, engaging in conversation with another person, or viewing a distant object like a movie theater screen.

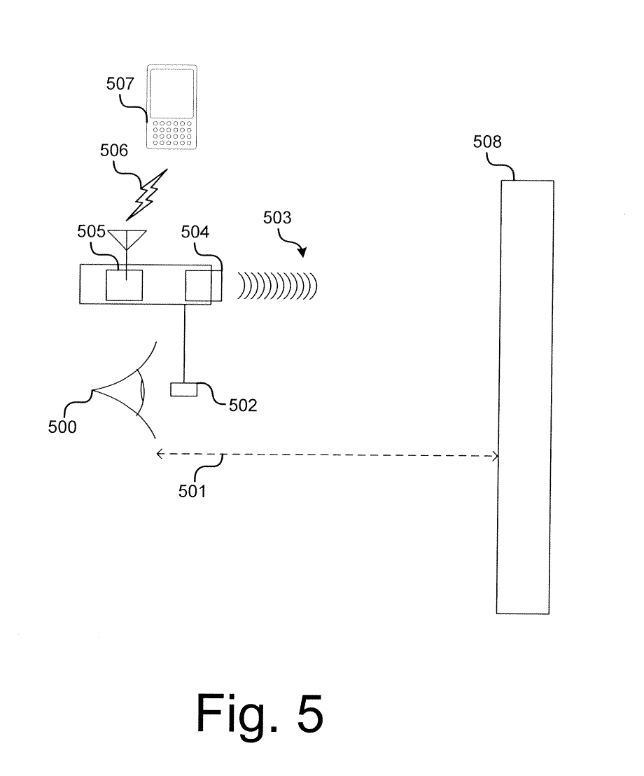

FIG. 5 illustrates another system for determining a viewing distance in accordance with an embodiment of the invention. In this embodiment, a measurement system 504 other than the radio subsystem 505 is used for the ranging operation. The measurement system 504 generates a ranging beam 503 along the viewing path 501 between the subject 500 and the object 508 being viewed. In some embodiments, the beam may be a laser, an ultrasonic beam, or a radio beam. If the beam 503 is a radio beam, it may be beam formed using antennas other than those in module 505, or may be formed using other methods, such as apertures. After determining the viewing distance 501, the measurement system 504 causes the eyepiece optical system 502 to adjust the apparent distance of the displayed virtual image.

Additionally, other features may be implemented in conjunction with the above described methods. For example, the measurement systems may be operable to communicate the measured viewing distance to the controllers. The controller may then modify the information content type according to the viewed distance. For example, sub-titles might be displayed if viewing a movie screen at infinity, while annotations might be displayed if viewing a nearby object.

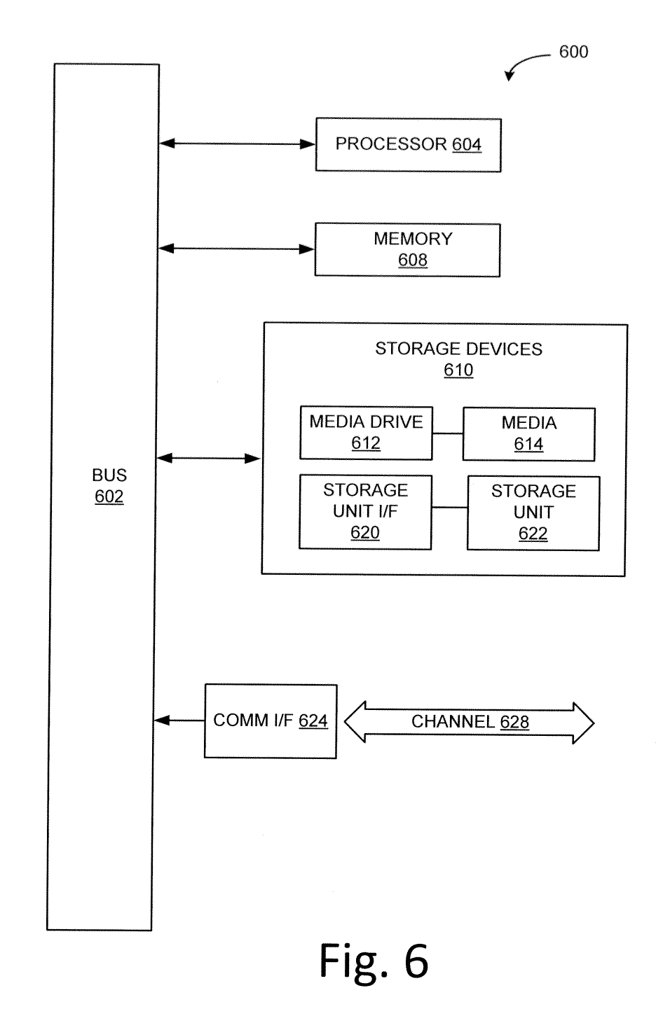

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or ore common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 6. Various embodiments are described in terms of this example—computing module 600. After reading this description, it will become apparent to a person skilled in the relevant art how to implement the invention using other computing modules or architectures.

Referring now to FIG. 6, computing module 600 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 600 might also represent computing capabilities embedded within or otherwise available to a given device. For example, a computing module might be found in other electronic devices such as, for example, digital ca eras, navigation systems, cellular telephones, portable computing devices, modems, routers, WAPs, terminals and other electronic devices that might include some for of processing capability.

Computing module 600 might include, for example, one or more processors, controllers, control modules, or other processing devices, such as a processor 604. Processor 604 might be implemented using a general-purpose or special-purpose processing engine such as, for example, a microprocessor, controller, or other control logic. In the illustrated example, processor 604 is connected to a bus 602, although any communication medium can be used to facilitate interaction with other components of computing module 600 or to communicate externally.

Computing module 600 might also include one or more memory modules, simply referred to herein as main memory 608. For example, preferably random access memory (RAM) or other dynamic memory, might be used for storing information and instructions to be executed by processor 604. Main memory 608 might also be used for storing temporary variables or other intermediate information during execution of instructions to be executed by processor 604. Computing module 600 might likewise include a read only memory (“ROM”) or other static storage device coupled to bus 602 for storing static information and instructions for processor 604.

The computing module 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a floppy disk drive, a magnetic tape drive, an optical disk drive, a CD or DVD drive (R or RW), or other removable or fixed media drive might be provided. Accordingly, storage media 614 might include, for example, a hard disk, a floppy disk, magnetic tape, cartridge, optical disk, a CD or DVD, or other fixed or removable medium that is read by, written to or accessed by media drive 612. As these examples illustrate, the storage media 614 can include a computer usable storage medium having stored therein computer software or data.

In alternative embodiments, information storage mechanism 610 might include other similar instrumentalities for allowing computer programs or other instructions or data to be loaded into computing module 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory module) and memory slot, a PCMCIA slot and card, and other fixed or removable storage units 622 and interfaces 620 that allow software and data to be transferred from the storage unit 622 to computing module 600.

Computing module 600 might also include a communications interface 624. Communications interface 624 might be used to allow software and data to be transferred between computing module 600 and external devices. Examples of communications interface 624 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 624 might typically be carried on signals, which can be electronic, electromagnetic (which includes optical) or other signals capable of being exchanged by a given communications interface 624. These signals might be provided to communications interface 624 via a channel 628. This channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 608, storage unit 620, media 614, and channel 628. These and other various forms of computer program media or computer usable media may be involved in carrying one or more sequences of one or more instructions to a processing device for execution. Such instructions embodied on the medium generally referred to as “computer program code” or a “computer program product” (which may be grouped in the form of computer programs or other groupings). When executed, such instructions might enable the computing module 600 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method, comprising:
determining a viewing distance from a user of a head-mounted display to an object being viewed by the user; and
using the viewing distance, adjusting a focal length of an eyepiece optical system of the head-mounted display to modify the apparent distance of a virtual image of an image displayed in the head-mounted display.

2. The method of claim 1, wherein the step of determining the viewing distance comprises performing a ranging operation.

3. The method of claim 2, wherein the step of determining the viewing distance comprises performing the ranging operation using a radio module mounted in the head-mounted display.

4. The method of claim 3, wherein the step of performing the ranging operation comprises beamforming using antennas contained in the radio module to provide a ranging path to the object.

5. The method of claim 3, wherein the determined viewing distance is a course measure ent of the range from the user's eye to the bi-ocular image on which both eyes are focused.

6. The method of claim 3, further comprising quantizing the determined viewing distance to a plurality of discrete values.

7. The method of claim 2, wherein the ranging operation is performed using an ultrasonic module, a laser,

8. The method of claim 1, wherein the step of determining the viewing distance comprises measuring the focal length of the user's eye lens.

9. The method of claim 8, wherein the step of measuring the focal length of the user's eye lens comprises viewing the retina of the user's eye using a camera mounted to the head-mounted display.

10. The method of claim 9, wherein the step of measuring the focal length of the user's eye lens further comprises adjusting a focal length of an optical system mounted in the camera to focus the image of the retina.

11. The method of claim 9, wherein the step of measuring the focal length of the user's eye lens fu her comprises illuminating the retina with an infrared light, and wherein the ca era comprises an infrared camera.

12. The method of claim 8, wherein the step of measuring the focal length of the user's eye lens comprises capturing a reflection of the virtual image from the retina of the user's eye using a camera mounted to the head-mounted display.

13. The method of claim 1, further comprising transmitting information regarding the determined viewing distance to a controller of the head-mounted display.

14. The method of claim 13, further comprising transmitting information content from the controller to the head-mounted display based on the information regarding the determined viewing distance.

15. The method of claim 1, wherein the viewing distance is a distance between the head mounted display and the object being viewed.

16. The method of claim 1, wherein the viewing distance is the distance from the user's lens to the object being viewed.

17. The method of claim 1, wherein the apparent distance of the virtual image is modified to correspond to the viewing distance.

18. Non-transitory computer readable storage storing instructions configured to cause a device to perform the steps of:
determining a viewing distance from a user of a head-mounted display to an object being viewed by the user; and
using the viewing distance, adjusting a focal length of an eyepiece optical system of the head-mounted display to modify the apparent distance of a virtual image of an image displayed in the head-mounted display.

19. The non-transitory computer readable storage of claim 18, wherein the step of determining the viewing distance comprises performing a ranging operation using a radio module mounted in the head-mounted display.

20. The non-transitory computer readable storage of claim 19, wherein the step of performing the ranging operation comprises beamforming using antennas contained in the radio module to provide a ranging path to the object.

21. The non-transitory computer readable storage of claim 19, wherein the determined viewing distance is a course measurement of the range from the user's eye to the bi-ocular image on which both eyes are focused.

22. The non-transitory computer readable storage of claim 19, wherein the steps further comprise quantizing the determined viewing distance to a plurality of discrete values.

23. The non-transitory computer readable storage of claim 18, wherein the step of determining the viewing distance comprises measuring the focal length of the user's eye lens.

24. The non-transitory computer readable storage of claim 23, wherein the step of measuring the focal length of the user's eye lens comprises viewing the retina of the user's eye using a camera mounted to the head-mounted display.

25. The non-transitory computer readable storage of claim 24, wherein the step of measuring the focal length of the user's eye lens further comprises adjusting a focal length of an optical system mounted in the camera to focus the image of the retina.

26. The non-transitory computer readable storage of claim 24, wherein the step of measuring the focal length of the user's eye lens further comprises illuminating the retina with an infrared light, and wherein the camera comprises an infrared camera.

27. The non-transitory computer readable storage of claim 23, wherein the step of measuring the focal length of the user's eye lens comprises capturing a reflection of the virtual image from the retina of the user's eye using a camera mounted to the head-mounted display.

28. A head mounted display, comprising:
a display;
an eyepiece optical system configured to display a virtual image to a user, the eyepiece optical system having adjustable focal length; and
a measurement system configured to determine a viewing distance from the user to an object being viewed by the user.

29. The head mounted display of claim 28, further comprising a link between the measurement system and the eyepiece optical system operable to allow the measurement system to control the adjustable focal length of the eyepiece optical system.

30. The head mounted display of claim 28, further comprising a radio module operable to connect to a controller.

31. The head mounted display of claim 30, wherein the measurement system comprises the radio module and determines the viewing distance using a ranging operation performed by the radio module.

32. The head mounted display of claim 30, wherein the radio module comprises multiple antennas and is operable to beam form to provide a ranging path to the object.

33. The head mounted display of claim 30, wherein the measurement system is operable to report the determined viewing distance to the controller using the radio module.

34. The head mounted display of claim 28, wherein the measurement system comprises a camera configured to view the retina of the user's eye.

35. The head mounted display of claim 34, wherein the display and eyepiece optical system are operable to project a test image on the retina of the user's eye for the camera to view.

36. The head mounted display of claim 34, further comprising an infrared illumination system operable to illuminate the retina.
